(19) United States
(12) Patent Application Publication
(10) Pub. No.: US 2026/0076173 A1
(43) Pub. Date: Mar. 12, 2026

(54) SEMICONDUCTOR DEVICE AND METHOD OF DESIGNING THE SAME

(71) Applicant: Renesas Electronics Corporation, Tokyo (JP)

(72) Inventor: Masahiro HASEGAWA, Tokyo (JP)

(21) Appl. No.: 19/241,766

(22) Filed: Jun. 18, 2025

(30) Foreign Application Priority Data
Sep. 10, 2024 (JP) 2024-156819

(51) Int. Cl. H01L 23/528; G06F 30/392; G06F 115/08; G06F 117/12; H01L 23/00; H01L 23/522; H10D 80/20

(52) U.S. Cl. CPC H10W 20/435; G06F 30/392; H10D 80/251; H10W 20/42; G06F 2115/08; G06F 2117/12; H10W 72/921; H10W 72/932

(57) ABSTRACT

Without causing characteristic variations in paired elements, the increase in development cost and development period is suppressed. A plurality of MOS units 30 are arranged adjacent to each other on a main surface of a semiconductor substrate in a plan view, each of the plurality of MOS unit is comprised of at least one MOSFET and has same structure. Above the plurality of MOS units 30, a multilayer wiring layer is formed. In an uppermost wiring layer of the multilayer wiring layer, wiring M8 is formed. Each of the plurality of MOS units 3Q includes MOS unit 10 and MOS unit 20, which constitute a part of the differential circuit as paired elements. The coverage rate of MOS unit 10 covered by wiring M8 is the same as the coverage rate of MOS unit 20 covered by wiring M8 in the plan view.

### CROSS-REFERENCE TO RELATED APPLICATIONS

The disclosure of Japanese Patent Application No. 2024-156819 filed on Sep. 10, 2024, including the specification, drawings and abstract is incorporated herein by reference in its entirety.

### BACKGROUND

The present invention relates to a semiconductor device and its design method, particularly to a semiconductor device comprising paired elements that form part of a differential circuit, and its design method.

There are disclosed techniques listed below.
[Patent Document 1] Japanese Unexamined Patent Application Publication No. 2014-138104

Semiconductor devices are equipped with terminals for external connections to connect with other semiconductor devices or wiring substrates. For example, Patent Document 1 discloses a technique for electrically connecting the pad electrodes of a semiconductor chip to a package substrate and connecting the solder balls of the package substrate to the wiring of a printed circuit board.

### SUMMARY

The topmost wiring layer of a semiconductor chip has a plurality of wirings formed, some of which are used as pad electrodes for connecting bump electrodes or wires. Typically, the wiring thickness of the topmost wiring layer is the thickest among the wirings formed on the semiconductor chip.

When a MOSFET (Metal Oxide Semiconductor Field Effect Transistor) is formed beneath such thick wiring, it is known that the stress from these wirings can cause variations in the characteristics of the MOSFET. For example, the stress from the wiring of the topmost wiring layer can cause the drain saturation current (IDsat) of the MOSFET to vary by about +5%.

The semiconductor chip is equipped with analog IP (Intellectual Property) as a circuit function block with a specific role. The paired elements used in part of the differential circuit of the analog IP are constituted by a pair of MOS FETS with the same structure to obtain the same characteristics. Therefore, if characteristic variations occur in one MOSFET, the sensitivity of the differential circuit changes significantly. To avoid such characteristic variations, it is effective to arrange the wiring of the topmost wiring layer so as not to cover the paired elements.

The wiring of the upper layers, such as the topmost wiring layer, is often arranged in the latter part of the design. Also, the layout of the wiring in the topmost wiring layer may change depending on the specifications of the package for each product. If the paired elements are covered by the wiring of the topmost wiring layer after layout changes, it becomes necessary to move the paired elements, requiring a redesign of the floor plan around the analog IP. Consequently, there is a problem of increased development costs and time. Additionally, as process miniaturization progresses, the standards for analog IP become stricter, making it increasingly difficult to meet these standards.

Therefore, there is a demand for technology that can suppress the increase in development costs and time without causing characteristic variations in the paired elements. Furthermore, there is a demand for technology that makes it easier to meet the standards for analog IP even as process miniaturization progresses. Other problems and novel features will become apparent from the description and accompanying drawings of this specification.

A brief overview of the typical embodiments disclosed in this application is as follows.

A semiconductor device according to one embodiment comprises a semiconductor substrate having a first surface, a plurality of MOS units arranged adjacent to each other on the first surface of the semiconductor substrate, each of the plurality of MOS units is comprised of at least one MOSFET and has same structure, a multilayer wiring layer formed above the plurality of the MOS units, and a first wiring formed on the topmost wiring layer of the multilayer wiring layer. Each of the plurality of the MOS units includes a first MOS unit and a second the MOS unit constituting part of a differential circuit as pair elements, and in the plan view, a coverage rate of the first the MOS unit covered by the first wiring is the same as a coverage rate of the second the MOS unit covered by the first wiring.

A design method for a semiconductor device according to one embodiment includes: (a) preparing a plurality of MOS units arranged adjacent to each other on a first surface of the semiconductor substrate, each of the plurality of MOS units is comprised of at least one MOSFET and has same structure, (b) preparing a first wiring formed on the topmost wiring layer of the multilayer wiring layer formed above the plurality of MOS units, and (c) selecting a first MOS unit and a second MOS unit constituting part of a differential circuit as pair elements from the plurality of MOS units so that the coverage rate of the first MOS unit covered by the first wiring in the plan view is the same as the coverage rate of the second MOS unit covered by the first wiring in the plan view.

According to one embodiment, it is possible to suppress the increase in development costs and time without causing characteristic variations in the paired elements.

### BRIEF DESCRIPTION OF THE DRAWINGS

FIG. 1 is a plan view showing the semiconductor device according to the first embodiment.

FIG. 2 is an equivalent circuit diagram showing the analog IP including a differential circuit according to the first embodiment.

FIG. 3 is a plan view showing the layout of the pad electrodes and paired elements according to the first embodiment.

FIG. 4 is a plan view showing the state before and after the design change of the pad electrodes according to the first embodiment.

FIG. 5 is a plan view showing the layout of the pad electrodes and paired elements in an examined example.

FIG. 6 is a flowchart showing the design method of the semiconductor device according to the first embodiment.

FIG. 7 is a plan view showing the layout of the pad electrodes and paired elements according to the first embodiment.

FIG. 8 is a plan view for explaining the number of MOS units that can be arranged according to the first embodiment.

FIG. 9 is a cross-sectional view showing the semiconductor device according to the first embodiment.

FIG. 10 is a cross-sectional view showing a plurality of the MOS units according to the first embodiment.

FIG. 11 is a cross-sectional view showing a plurality of the MOS units according to the first embodiment.

FIG. 12 is a perspective view showing an example of the structure of a MOSFET in the first modified example.

FIG. 13 is a plan view showing the state before and after the design change of the pad electrodes in the second modified example.

FIG. 14 is an equivalent circuit diagram showing the analog IP including a differential circuit according to the second embodiment.

FIG. 15 is a plan view showing the layout of the pad electrodes and paired elements according to the second embodiment.

FIG. 16 is a plan view showing the layout of the pad electrodes and paired elements according to the second embodiment.

FIG. 17 is a plan view showing a plurality of the MOS units according to the second embodiment.

FIG. 18 is a cross-sectional view showing the semiconductor device according to the second embodiment.

FIG. 19 is an equivalent circuit diagram showing the analog IP including a differential circuit according to the third embodiment.

FIG. 20 is a plan view showing the layout of the pad electrodes and paired elements according to the third embodiment.

FIG. 21 is a plan view showing the layout of the pad electrodes and paired elements according to the third embodiment.

FIG. 22 is a plan view showing the MOS units that become paired elements according to the third embodiment.

FIG. 23 is a plan view showing the MOS units that become paired elements according to the third embodiment.

FIG. 24 is a plan view showing the MOS units that are unused according to the third embodiment.

FIG. 25 is a cross-sectional view showing the semiconductor device according to the third embodiment.

FIG. 26 is a plan view showing the layout of the pad electrodes and paired elements according to the fourth embodiment.

### DETAILED DESCRIPTION

Hereinafter, the embodiments will be described in detail with reference to the drawings. In all the drawings for explaining the embodiments, members having the same functions are denoted by the same reference numerals, and repetitive descriptions thereof are omitted. In the following embodiments, descriptions of the same or similar parts will not be repeated in principle except when particularly necessary.

In this application, the X, Y, and Z directions described intersect and are orthogonal to each other. In this application, the Z direction is described as the vertical direction, depth direction, or thickness direction of a structure. The expressions “plan view” or “plan view” used in this application mean viewing the plane constituted by the X and Y directions from the Z direction. The expressions “plan view” or “plan view” mean viewing the main surface of the semiconductor substrate SUB from above.

### First Embodiment

### <Plan Layout of Semiconductor Device>

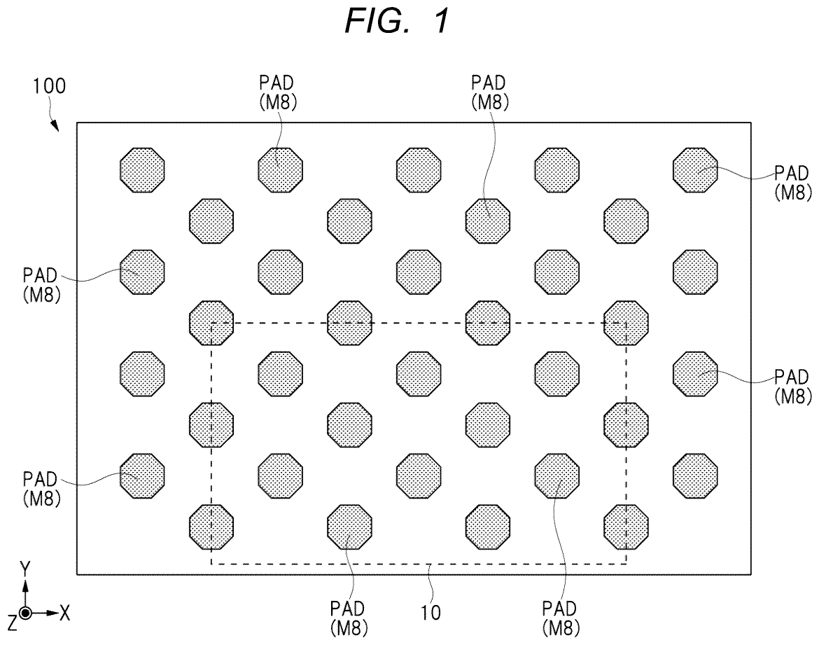

The semiconductor device 100 (semiconductor chip) according to the first embodiment will be described below with reference to FIGS. 1 to 9.

FIG. 1 is a plan view of the semiconductor device 100 viewed from above. As shown in FIG. 1, the semiconductor device 100 includes a plurality of pad electrodes PAD formed in the topmost wiring layer. The plurality of pad electrodes PAD is arranged in a staggered configuration. The number of the pad electrodes PAD shown in FIG. 1 is an example and can be changed as appropriate. By connecting an external connection member such as a bump electrode to the pad electrode PAD, the semiconductor device 100 can be electrically connected to other semiconductor chips or wiring substrates.

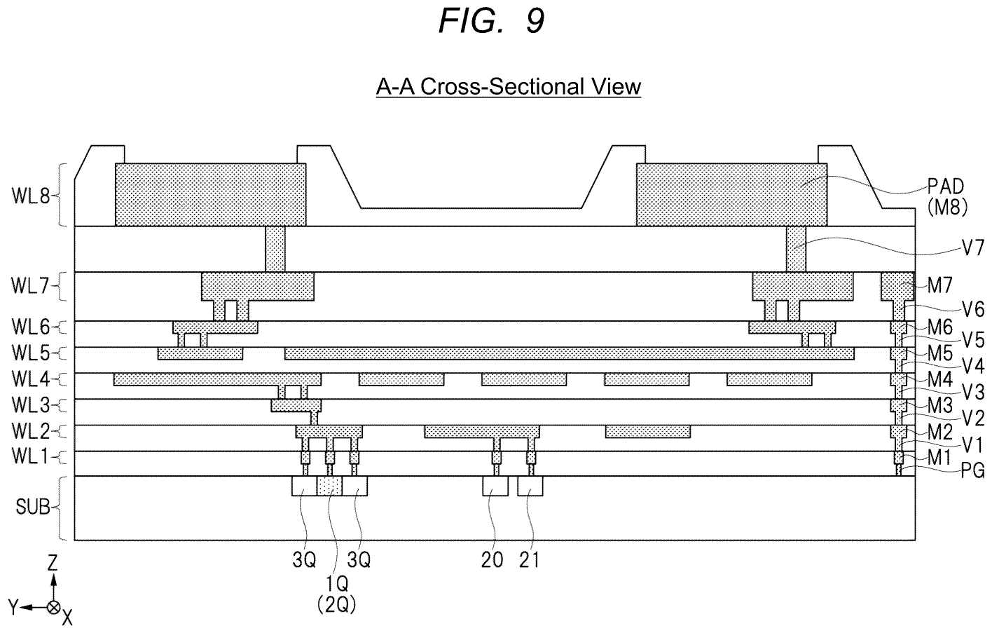

As shown in FIG. 9, the semiconductor device 100 includes a multilayer wiring layer comprised of wiring layers WL1 to WL8, with wiring layer WL8 constituting the topmost wiring layer. A plurality of wirings M8 are formed in wiring layer WL8. The pad electrode PAD is part of the plurality of wirings M8.

As shown in FIG. 1, semiconductor device 100 includes analog IP10 as a circuit function block with a specific role.

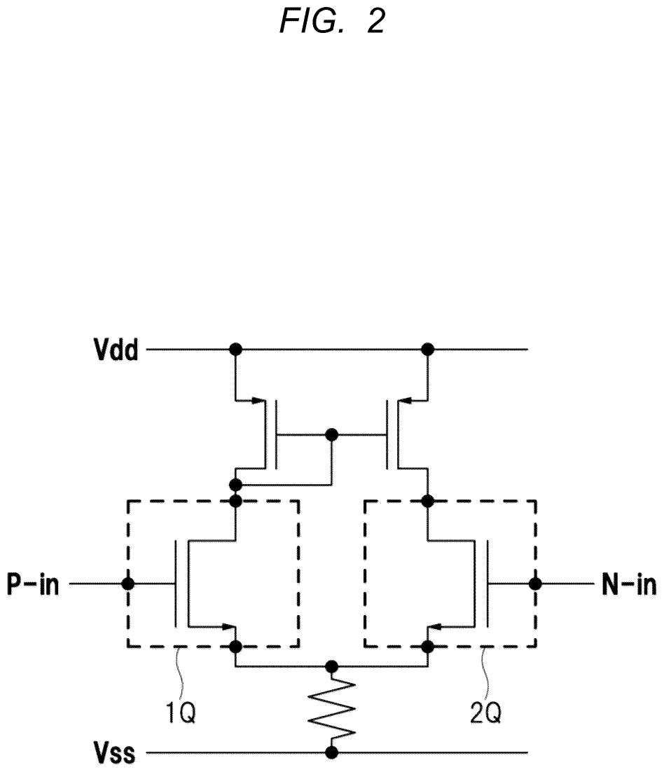

FIG. 2 shows a BGR (Bandgap Reference) circuit as a differential circuit included in the analog IP10 according to the first embodiment, a MOS unit 10 and a MOS unit 20 form part of the differential circuit as paired elements. In the first embodiment, the MOS unit 1Q and the MOS unit 20 are each comprised of a single n-type MOSFET.

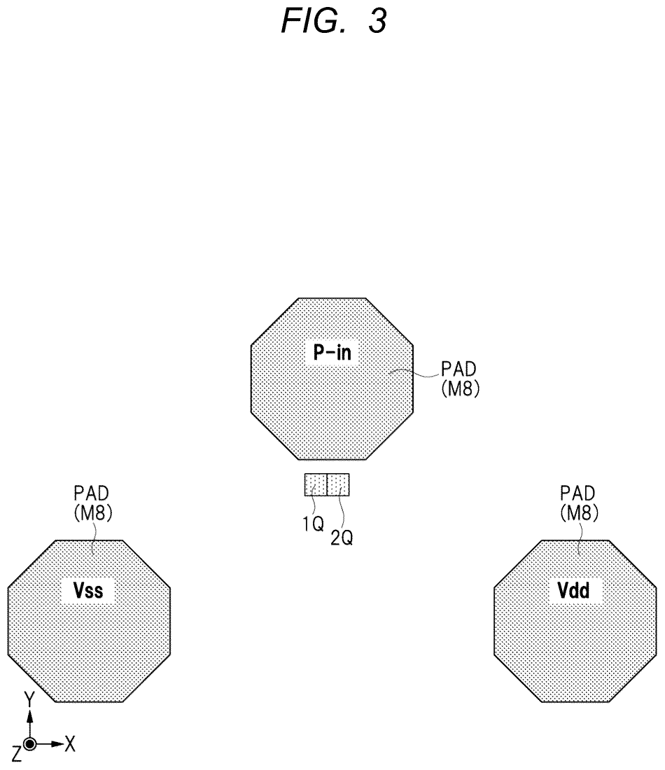

FIG. 3 is a plan view within the analog IP10, which is an enlarged portion of FIG. 1, showing the positional relationship between a plurality of pad electrodes PAD and the MOS units 10 and 2Q. To avoid characteristic variations as paired elements, the MOS units 10 and 20 are arranged such that a coverage rate of the MOS unit 10 covered by the pad electrode PAD is the same as that of the MOS unit 20 covered by the pad electrode PAD.

Here, the MOS units 10 and 20 are not covered by the pad electrode PAD (wiring M8). However, if the coverage rate of the MOS unit 10 is the same as that of the MOS unit 20, all of the MOS unit 10 and all of the MOS unit 20 may be covered by wiring M8, or parts of the MOS unit 10 and parts of the MOS unit 20 may be covered by wiring M8.

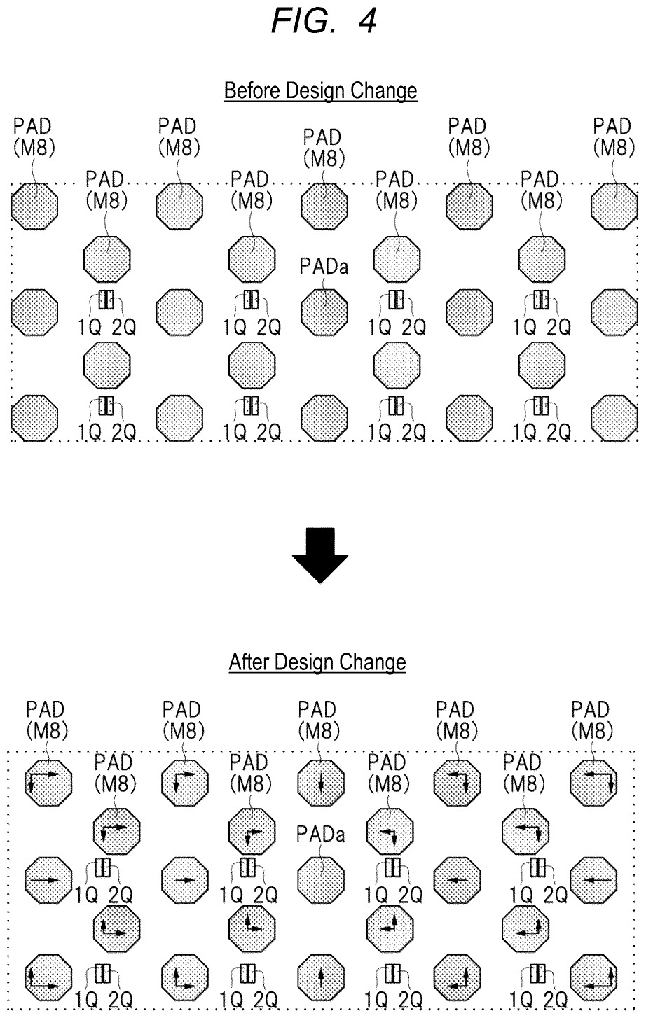

As shown in FIG. 4, for example, due to specification changes in the package for each product, the pitch between each pad electrode PAD (the pitch between each wiring M8) may change. In such cases, since the arrangement positions of the MOS units 1Q and 20 do not change, a misalignment occurs in the positional relationship between the pad electrode PAD and the MOS units 10 and 2Q. In FIG. 4, the pitch becomes uniformly narrower relative to the reference pad electrode PADa, and further away from the reference pad electrode PADa, the greater the movement of the pad electrode PAD. That is, the further away from the reference pad electrode PADa, the greater the misalignment in the positional relationship between the pad electrode PAD and the MOS units 10 and 20.

For example, when a pad electrode PAD that is one pitch away from the reference pad electrodes PADa in the X or Y direction moves 5 μm towards the reference pad electrode PADa, a pad electrode PAD that is two pitches away from the reference pad electrode PADa in the X or Y direction moves 10 μm towards the reference pad electrode PADa.

As a result, the coverage rates of the MOS unit 10 and the MOS unit 20 may change, and for example, the coverage rates of the MOS unit 10 and the MOS unit 20 may become different values. As a countermeasure in such cases, the design method of the examined example and the design method of the first embodiment will be described.

### Design Method of the Examined Example

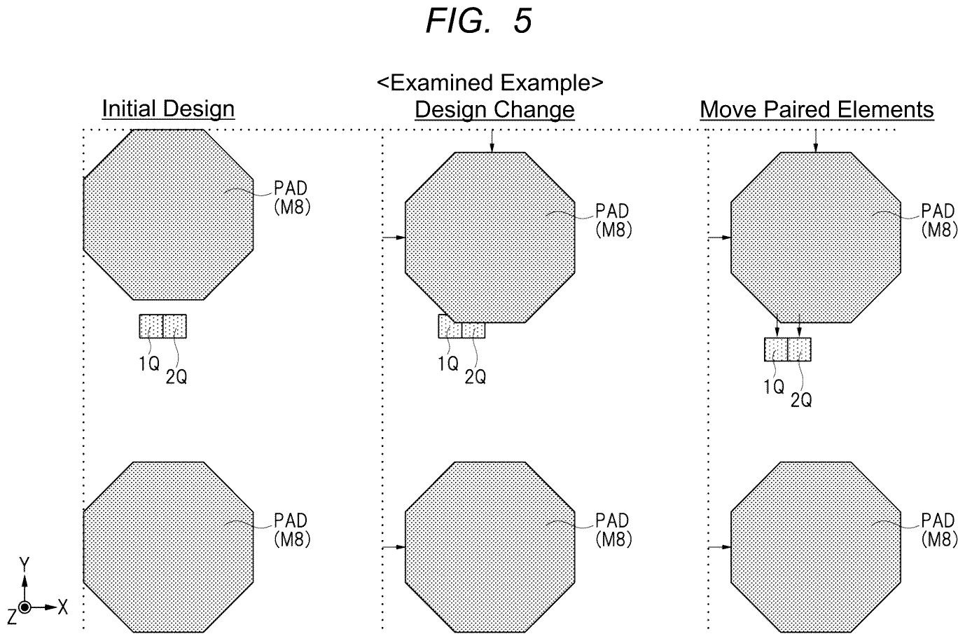

In the examined example, as shown in “Initial Design” in FIG. 5, the pitch between each wiring M8 is designed so that the MOS units 10 and 20 are not covered by the pad electrode PAD (wiring M8), and the layout of a plurality of wirings M8 is performed.

Next, as shown in “Design Change” in FIG. 5, the pitch between each wiring M8 may change. Then, parts of the MOS unit 1Q and parts of the MOS unit 20 may be unevenly covered by the pad electrode PAD. That is, the coverage rate of the MOS unit 1Q may become different from the coverage rate of the MOS unit 20.

In such cases, as shown in “Move Paired Elements” in FIG. 5, the arrangement positions of the MOS units 10 and 20 are changed to avoid characteristic variations as paired elements. However, this requires redoing the floor plan design around the analog IP10, increasing development costs and time. For example, although only the paired elements (the MOS units 10, 20) are illustrated here, other elements used in the analog IP10 are also densely packed around them. Since the arrangement positions of these other elements also need to be changed, significant development costs and time are required.

### Design Method of the First Embodiment

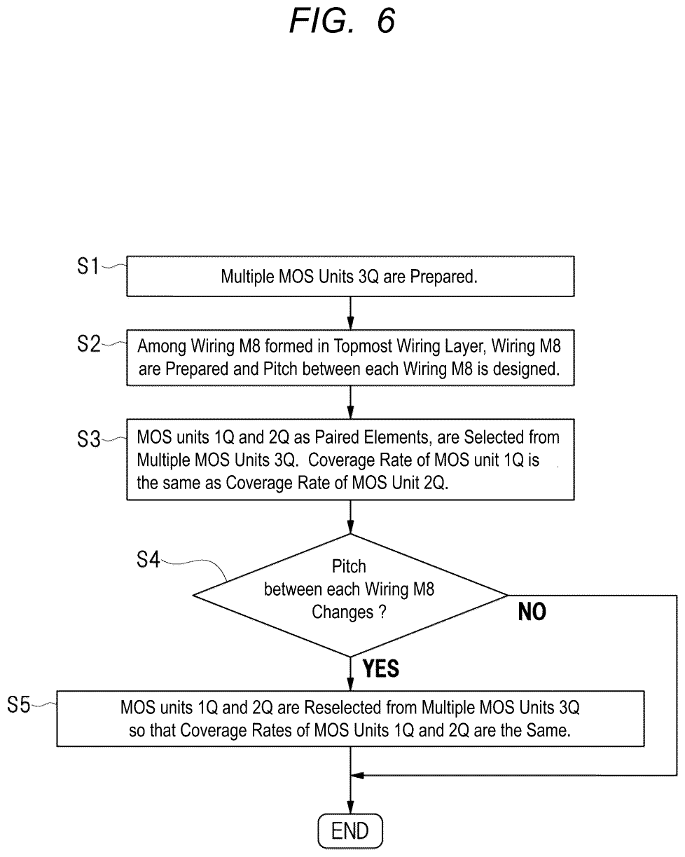

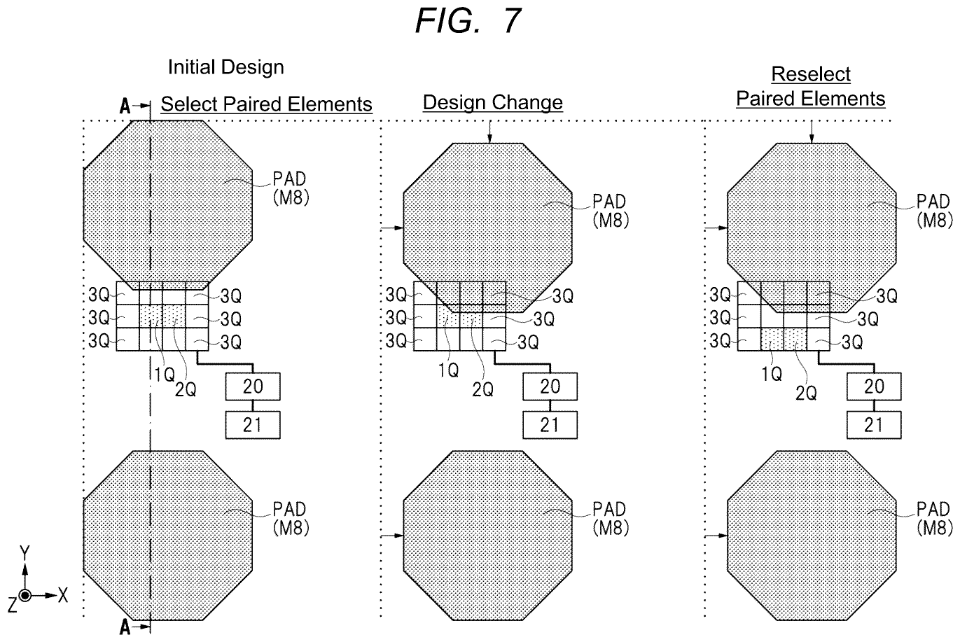

The design method of the semiconductor device 100 in the first embodiment will be described using FIGS. 6 and 7. The design method of the semiconductor device 100 includes steps S1 to S5 shown in FIG. 6.

First, in step S1, as shown in “Initial Design” in FIG. 7, a plurality of MOS units 30, which are arranged adjacent to each other on the main surface of the semiconductor substrate in a plan view, are prepared. Each of the plurality of the MOS units 3Q is composed of at least one MOSFET and has the same structure. In the first embodiment, each of the plurality of the MOS units 3Q is composed of a single n-type MOSFET.

Next, in step S2, among the multilayer wiring layers formed above the plurality of the MOS units 30, a plurality of wirings M8 formed in the topmost wiring layer (wiring layer WL8) are prepared. Here, among the plurality of wirings M8, the wirings M8 used as the pad electrode PAD is prepared. Then, the pitch between each wiring M8 is designed, and the layout of the plurality of wirings M8 is performed.

Next, in step S3, the MOS units 10 and 20, which constitute part of a differential circuit as paired elements, are selected from the plurality of the MOS units 30. Here, the MOS units 10 and 20 are selected so that the coverage rate of the MOS unit 10 covered by wiring M8 in a plan view is the same as the coverage rate of the MOS unit 20 covered by wiring M8 in a plan view.

Thus, in the first embodiment, by preparing the plurality of the MOS units 30 in advance as candidates for paired elements (the MOS units 10, 20), the MOS units 10 and 20 with the same coverage rate can be selected regardless of the layout situation of the plurality of wirings M8. Therefore, characteristic variations of paired elements do not occur. Also, unlike the examined example, there is no need to avoid the MOS units 10 and 2Q when laying out wiring M8, so the layout freedom of wiring M8 can be improved.

Note that among the plurality of the MOS units 30, other the MOS units 30 excluding the MOS units 10 and 20 are not used in differential circuits or other circuits. For example, the gate electrode, source region, and drain region of the n-type MOSFET of the unselected the MOS units 30 are each connected to a ground potential.

Then, as shown in “Design Change” in FIG. 7, the pitch between each wiring M8 may change. In step S4, if the pitch between each wiring M8 changes (YES), the MOS units 10 and 20 are reselected in step S5. If the pitch between each wiring M8 does not change (NO), step S5 is not necessary.

In step S5, as shown in “Reselect Paired Elements” in FIG. 7, the MOS units 10 and 20 are reselected from the plurality of the MOS units 30 so that the coverage rates of the MOS units 10 and 20 are the same.

Thus, in the first embodiment, even if the pitch between each wiring M8 changes, the MOS units 10 and 20 can be reelected, so characteristic variations of paired elements do not occur. Also, since there is no need to change the arrangement positions of other elements used in the analog IP10, the increase in development costs and time can be suppressed.

Note that even if the pitch between each wiring M8 changes in step S4, if the coverage rate of the MOS unit 10 is the same as that of the MOS unit 20, step S5 may not be performed. That is, if the coverage rate of the MOS unit 10 differs from that of the MOS unit 20, the MOS units 10 and 20 are reselected in step S5.

Also, in the first embodiment, to select the MOS units 10 and 20 from the plurality of the MOS units 30, a control circuit 20 and a register 21 electrically connected to the plurality of the MOS units 30 are prepared at the stage of step S1.

Once the layout of wirings M8 is determined, the coverage rate of each of the plurality of the MOS units 30 is determined. The register 21 stores information on the coverage rate covered by wirings M8 in a plan view for each of the plurality of the MOS units 30. In steps S3 and S5, the control circuit 20 automatically selects the MOS units 10 and 20 from the plurality of the MOS units 30, where the coverage rate covered by wirings M8 in a plan view is the same, based on the information in register 21.

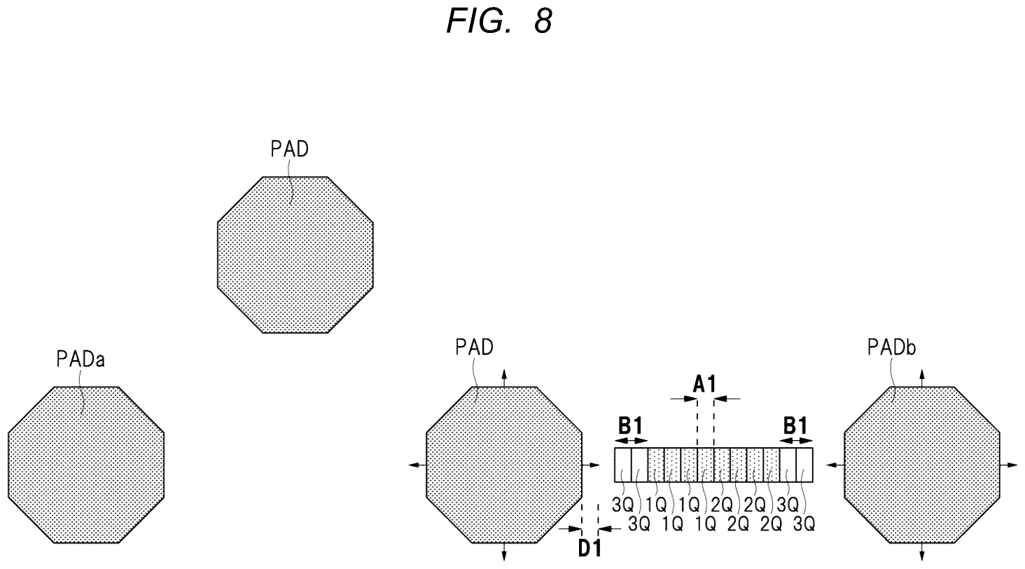

Using FIG. 8, the number of the MOS units that can be arranged between each pad electrode PAD will be explained. The number of the MOS units that can be arranged varies depending on the distance from the reference pad electrode PADa.

Let the size of one the MOS unit 10, 20, 30 be A1. Let N be the number of spare the MOS units 30 other than the MOS units 1Q and 2Q. The area B1 where the plurality of spare the MOS units 3Q are arranged can be expressed as “B1=A1×N”. Also, let D1 be the shift amount between each pad electrode PAD when the pitch changes, and let P be the number of pad electrodes PAD from the reference pad electrode PADa to the farthest pad electrode PADb. Note that pad electrodes PAD arranged in a staggered manner are counted as 0.5. Let the margin with the paired elements at the pad electrode PAD boundary be A1/2.

The maximum shift amount M of the pad electrode PAD as seen from the reference pad electrode PADa is “M=D1×P+ (A1/2)”. When the pad electrode PAD moves, region B1 where M<B1 is arranged in the direction where the pair element might be covered by the pad electrode PAD, allowing for the adjustment of coverage between the pad electrode PAD and the pair element. Such a relationship is also applicable in other embodiments described later.

### <Cross-Sectional Structure of the Semiconductor Device>

The cross-sectional structure of the semiconductor device 100 will be described below with reference to FIGS. 9 to 11. FIG. 9 is a cross-sectional view along line A-A shown in FIG. 7.

As shown in FIG. 9, the semiconductor device 100 includes a semiconductor substrate SUB, a plurality of the MOS units 30 formed on the main surface of the semiconductor substrate SUB, and a multilayer wiring layer formed above the plurality of the MOS units 30. As described above, each of the plurality of the MOS units 30 includes the MOS units 10 and 20, which constitute part of a differential circuit as pair elements.

The multilayer wiring layer includes wiring layers WL1 to WL8. Wiring M1 to wiring M8 formed on wiring layers WL1 to WL8, respectively. The wiring thickness of wiring M8 is thicker than the wiring thickness of wiring M1 to wiring M7 formed in the multilayer wiring layer. Here, an example of an 8-layer multilayer wiring layer is illustrated, but the number of layers in the multilayer wiring layer can be changed as appropriate.

The plurality of the MOS units 10, 20, 30, and wiring M1 are electrically connected by plugs PG. Wiring M1 to wiring M7 are electrically connected by vias V1 to V6, respectively. Wiring M7 and wiring M8 are electrically connected by via V7.

The plug PG is formed mainly of a tungsten film, for example. Wiring M1 to wiring M7 and vias V1 to V6 are wiring of a damascene structure or dual damascene structure, and are formed mainly of a copper film, for example. Via V7 is formed mainly of a tungsten film, for example. Wiring M8 is formed mainly of a patterned aluminum alloy film.

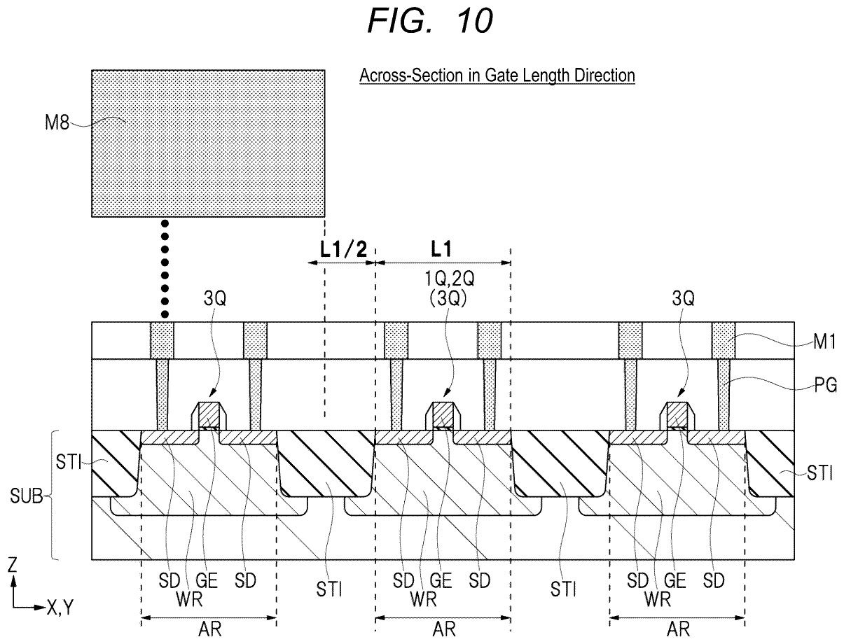

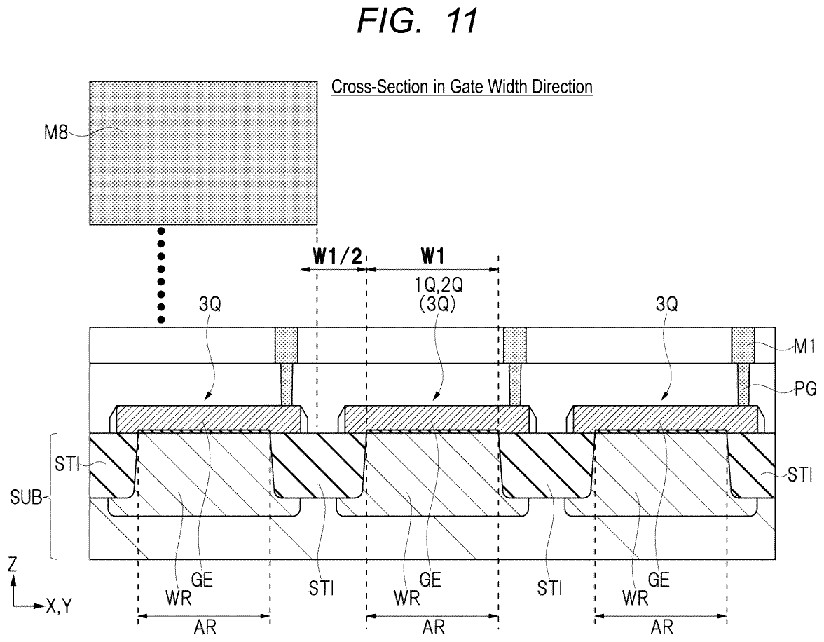

FIGS. 10 and 11 show the cross-sectional structure of the MOSFETs constituting the MOS units 10, 20, and 30. FIG. 10 shows a cross-section in the gate length direction of the MOSFET, and FIG. 11 shows a cross-section in the gate width direction of the MOSFET.

As shown in FIGS. 10 and 11, an element isolation part STI is formed in the semiconductor substrate SUB. The semiconductor substrate SUB is made of p-type silicon, for example. The element isolation part STI includes a groove formed in the semiconductor substrate SUB to reach a predetermined depth from the main surface of the semiconductor substrate SUB, and an insulating film embedded inside the groove. The insulation film is a silicon oxide film, for example.

Each MOSFET is formed in an active region AR surrounded by the element isolation part STI in a plan view of the semiconductor substrate SUB. A well region WR is formed in the semiconductor substrate SUB within the active region AR. A gate electrode GE is formed on the well region WR via a gate insulating film. The gate electrode GE is a polycrystalline silicon film, for example. An impurity region SD is formed in the well region WR. The impurity region SD constitutes the source region or drain region of the MOSFET. The well region WR located between the two impurity regions SD and under the gate electrode GE becomes the channel region of the MOSFET. The gate electrode GE and the impurity region SD are electrically connected to wiring M1 by the plug PG.

Each MOSFET in the first embodiment is an n-type MOSFET. In this case, the well region WR has p-type conductivity, and the gate electrode GE and the impurity region SD have n-type conductivity. In other embodiments described later, the MOSFETS constituting the MOS units 10, 20, and 30 may be p-type MOSFETs. In p-type MOSFETs, the well region WR has n-type conductivity, and the gate electrode GE and the impurity region SD have p-type conductivity.

As shown in FIG. 9, the semiconductor device 100 also includes a control circuit 20 and a register 21, but the control circuit 20 and the register 21 are configured using a plurality of MOSFETs as shown in FIGS. 10 and 11.

Here, the definition of the state where the MOS units 10, 20, and 30 are covered by wiring M8 will be described with reference to FIGS. 10 and 11. In the first embodiment, it is considered that the MOS units 10, 20, and 30 located near the boundary with wiring M8 may be somewhat affected by the stress from wiring M8, and in practice, even the MOS units 10, 20, and 30 not covered by wiring M8 may be defined as being covered by wiring M8.

The distance of active region AR in the gate length direction of the MOSFET is L1, and the distance of the active region AR in the gate width direction of the MOSFET is W1. In the first embodiment, if the MOSFETs included in the MOS units 10, 20, and 30 not covered by wiring M8 are formed in an active region AR that is L1/2 or less or W1/2 or less away from wiring M8 in a plan view, those the MOS units 10, 20, and 30 are considered to be covered by wiring M8 in a plan view.

### First Modified Example

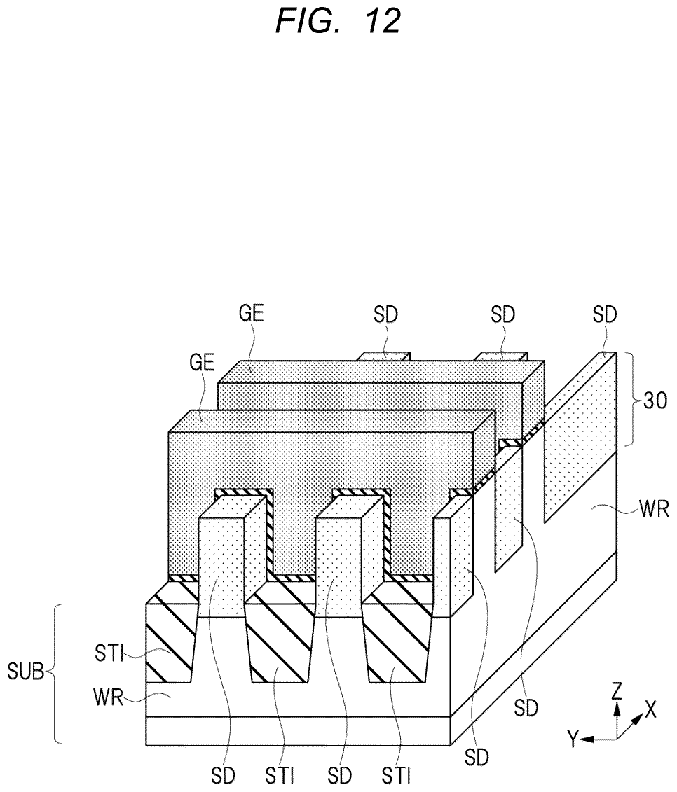

The first modified example of the first embodiment will be described below. In FIGS. 10 and 11, a planar structure MOSFET is illustrated, but the MOSFET may have a FIN-FET structure. The FIN-FET structure of the MOSFET will be described with reference to FIG. 12.

As shown in FIG. 12, a plurality of protrusions 30, which are part of the semiconductor substrate SUB, are provided on the semiconductor substrate SUB. The plurality of protrusions 30 extend in the X direction and are separated from each other in the Y direction. An element isolation part STI is formed on the semiconductor substrate SUB located between the plurality of protrusions 30. In other words, the space between the plurality of protrusions 30 corresponds to a groove formed in the semiconductor substrate SUB, and the element isolation part STI is formed inside the groove. The position of the upper surface of the element isolation part STI is lower than the position of the upper surface of the protrusions 30.

The gate electrode GE extends in the Y direction and is formed to cover the upper surface and both side surfaces of at least one of the protrusions 30. The gate insulating film is formed between the gate electrode GE and the protrusions 30. Well region WR is formed in the semiconductor substrate SUB including protrusions 30. The impurity region SD is formed in protrusions 30 (within well region WR) exposed from the gate electrode GE.

In the case of the FIN-FET structure, well region WR covered by the gate electrode GE and located between the two impurity regions SD, which become the source region or drain region, becomes the channel region of the MOSFET.

In the FIN-FET structure MOSFET, compared to the planar structure MOSFET, more MOSFETs can be arranged in the same planar area, and the gate width per MOSFET can be widened in the same planar area. Therefore, in the FIN-FET structure MOSFET, more drive current can be secured compared to the planar structure MOSFET, and the miniaturization of the semiconductor device 100 can be promoted.

### Second Modified Example

The second modified example of the first embodiment will be described below. In the first embodiment, as shown in FIG. 4, when the pitch between each pad electrode PAD (the pitch between each wiring M8) is changed, an example where the pitch is uniformly narrowed with respect to the reference pad electrode PADa was shown.

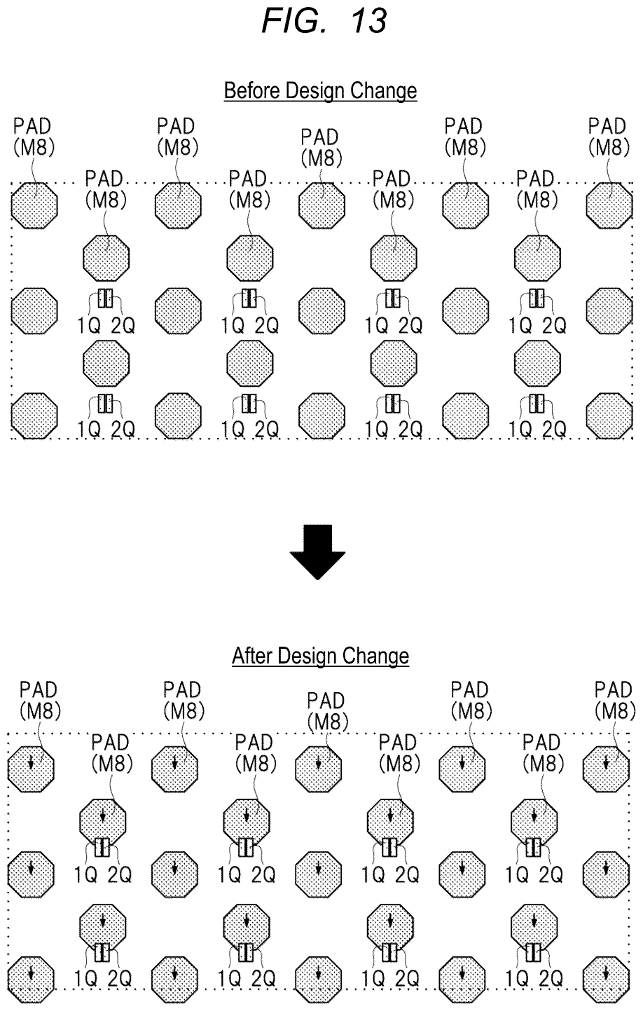

However, as shown in FIG. 13, there may be cases where the pitch between each pad electrode PAD is not changed due to product specifications, but fine adjustments to the position of each pad electrode PAD are required. In other words, there may be cases where the entire pad electrode PAD is uniformly shifted in the Y direction or X direction. In such cases, by preparing a plurality of the MOS units 30 in advance as candidates for pair elements (the MOS units 1Q, 20), it is possible to prevent characteristic variations of the pair elements.

### Second Embodiment

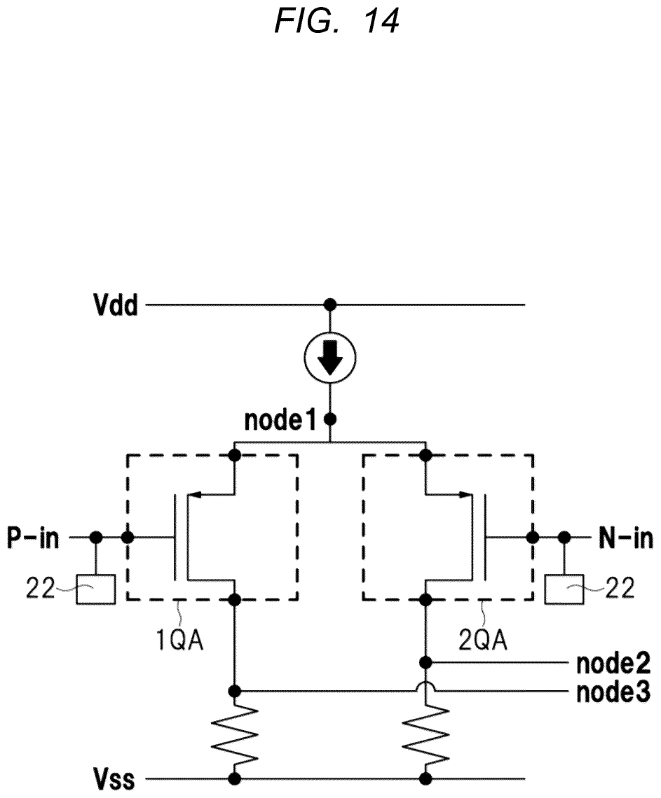

The semiconductor device 100 in the second embodiment will be described below with reference to FIGS. 14 to 18. In the following description, the differences from the first embodiment will be mainly described, and the points overlapping with the first embodiment will be omitted.

FIG. 14 shows the first-stage switch of a differential input circuit as a differential circuit included in the analog IP10 in the second embodiment. MOS unit groups 1QA and 2QA constitute part of the differential circuit as pair elements and are electrically connected to the ESD protection circuit 22.

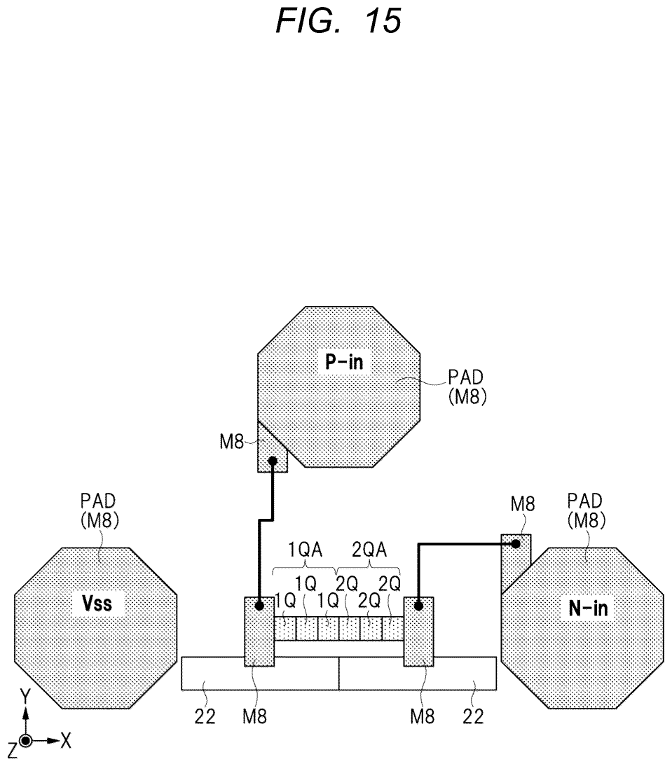

As shown in FIG. 15, the MOS unit group 1QA consists of a plurality of the MOS units 10, and the MOS unit group 2QA consists of a plurality of the MOS units 20. The number of the plurality of the MOS units 10 is equal to the number of the plurality of the MOS units 20. In the second embodiment, each MOS unit 10 and MOS unit 20 is composed of one p-type MOSFET.

In the equivalent circuit diagram of FIG. 14, the MOS unit group 1QA shows a state where a plurality of the MOS units 10 are connected in parallel with each other, and the MOS unit group 2QA shows a state where a plurality of the MOS units 20 are connected in parallel with each other.

Additionally, as shown in FIG. 15, a separate wiring M8 from the pad electrode PAD is provided above the MOS unit group 1QA and the MOS unit group 2QA to establish electrical connection with the ESD protection circuit 22.

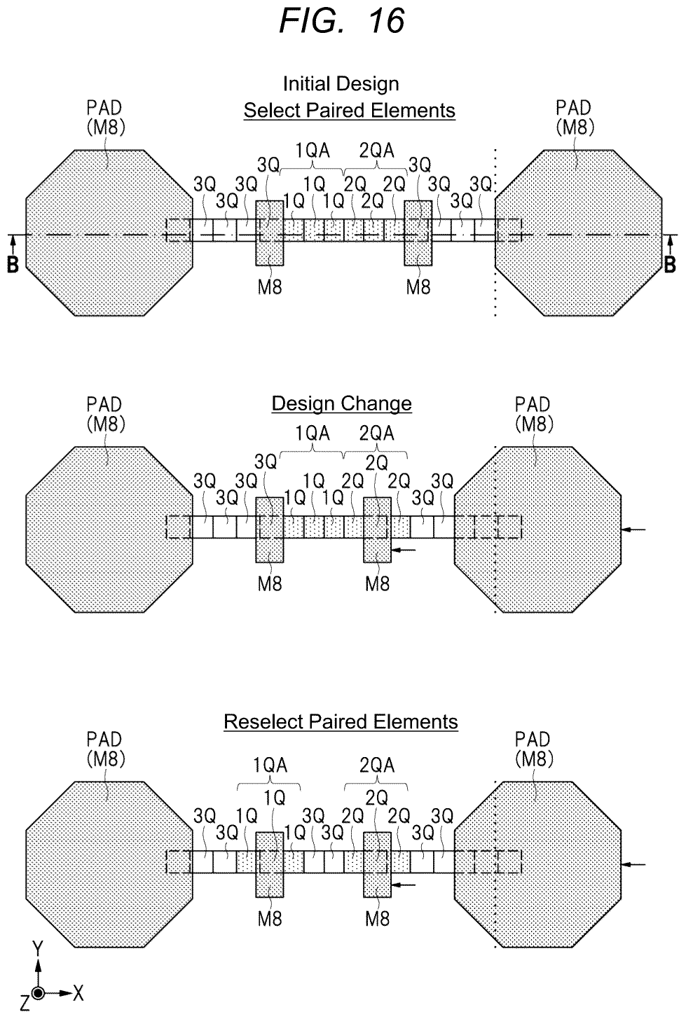

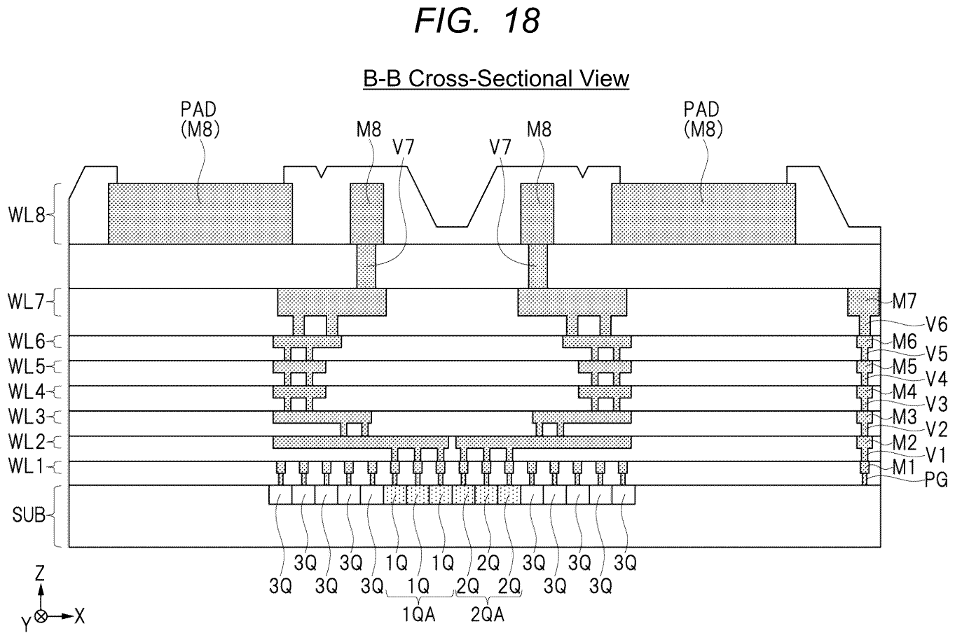

The design method of the semiconductor device 100 in the second embodiment will be described below using FIGS. 16 to 18. FIG. 18 is a cross-sectional view along line B-B shown in FIG. 16. In the second embodiment, steps S1 to S5 shown in FIG. 6 are carried out in the same manner as in the first embodiment.

First, in step S1, as shown in “Initial Design” of FIG. 16, a plurality of the MOS units 30, which are arranged adjacent to each other on the main surface of the semiconductor substrate in a plan view, are prepared. Each of the plurality of the MOS units 30 is comprised of one p-type MOSFET.

Next, in step S2, among the multilayer wiring layers formed above the plurality of the MOS units 30, a plurality of wirings M8 formed in the uppermost wiring layer (wiring layer WL8) are prepared. Then, the pitch between each wiring M8 is designed, and the layout of the plurality of wirings M8 is performed.

Next, in step S3, as shown in FIG. 18, a plurality of the MOS units 10 and a plurality of the MOS units 20, which constitute part of the differential circuit as pair elements, are selected from the plurality of the MOS units 30. Here, the coverage rate of the MOS unit group 10A covered by the wiring M8 in a plan view is the same as the coverage rate of the MOS unit group 2QA covered by the wiring M8 in a plan view. Therefore, in the second embodiment, as in the first embodiment, characteristic variations of the pair elements do not occur.

Note that among the plurality of the MOS units 30, other MOS units 30 excluding the MOS unit group 1QA and the MOS unit group 2QA are not used in the differential circuit and other circuits. In the second embodiment, a control circuit 20 and a register 21 are not used to select the plurality of the MOS units 1Q and the plurality of the MOS units 20. Instead, a plurality of wirings formed in a wiring layer lower than the wiring layer WL8 and used for the connection of the differential circuit are used.

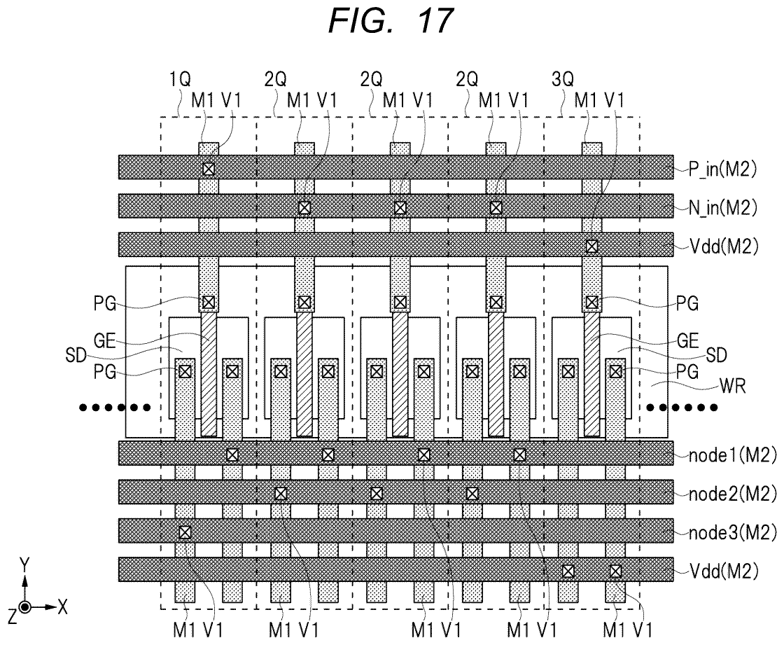

For example, as shown in FIG. 17, the gate electrode GE and the impurity region SD of the MOSFET are electrically connected to a plurality of wirings M1 by plugs PG, respectively. The plurality of wiring M1 is electrically connected to a plurality of wiring M2 by vias V1, respectively.

By changing the arrangement of the vias V1 connecting the wiring M1 and the wiring M2, the plurality of the MOS units 1Q and the plurality of the MOS units 20 can be electrically connected to the wiring corresponding to the equivalent circuit of FIG. 14, and the plurality of the MOS units 30 that were not selected can be rendered unusable. For example, the gate electrode GE and the impurity region SD of the p-type MOSFET of the unselected the MOS unit 30 are connected to the power supply potential Vdd, respectively.

In the case of pair elements through which a large current flows, such as switches in a differential input circuit, using the control circuit 20 may cause the resistance component to affect the characteristics of the pair elements. Therefore, by switching the wiring through the change in the arrangement of the vias V1, the influence of the resistance component on the current path of the differential input circuit can be avoided. Moreover, such a configuration can minimize the wiring load connected to the pair elements.

Subsequently, as shown in “Design Change” of FIG. 16, the pitch between each wiring M8 may be changed. In step S4, if the pitch between each wiring M8 is changed (YES), in step S5, the plurality of the MOS units 10 and the plurality of the MOS units 20 are reselected.

In step S5, as shown in “Reselection of Pair Elements” of FIG. 16, the plurality of the MOS units 10 and the plurality of the MOS units 20 are reselected from the plurality of the MOS units 30 so that the coverage rate of the MOS unit group 1QA and the coverage rate of the MOS unit group 2QA are the same.

Thus, in the second embodiment, as in the first embodiment, even if the pitch between each wiring M8 is changed, the plurality of the MOS units 10 and the plurality of the MOS units 20 can be reelected, so characteristic variations of the pair elements do not occur.

### Third Embodiment

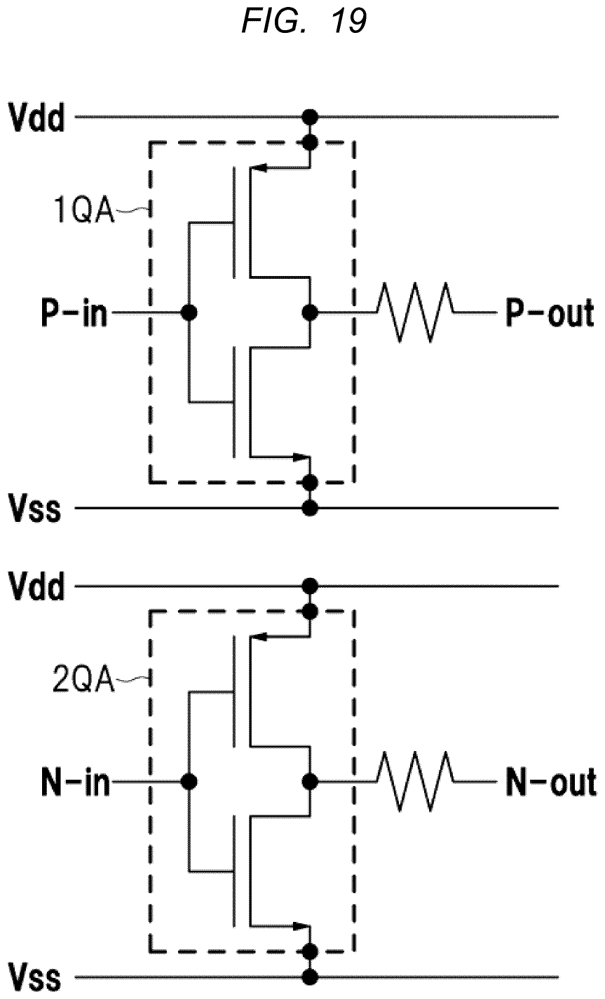

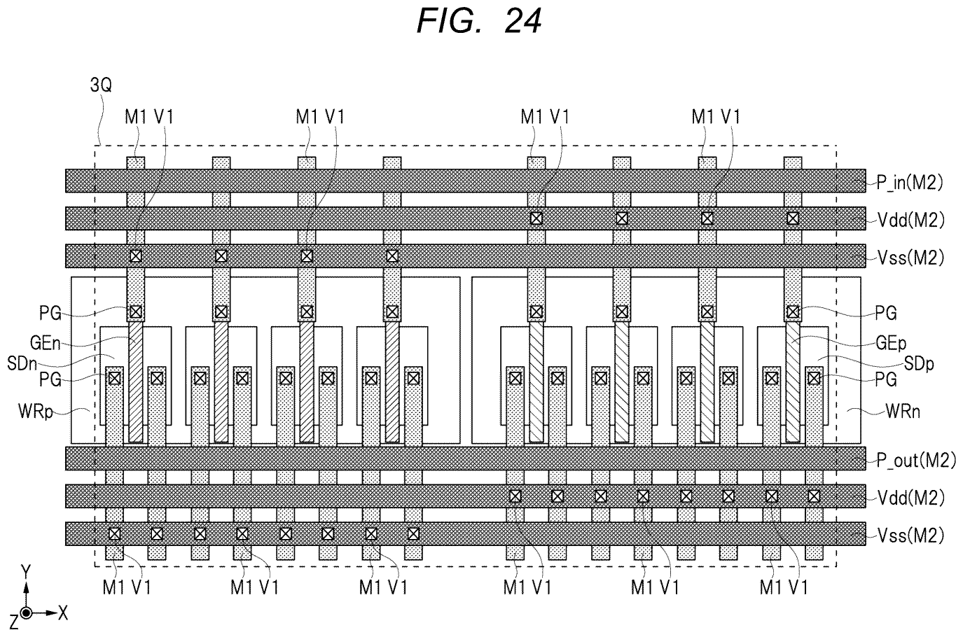

Below, using FIGS. 19 to 25, the semiconductor device 100 in the third embodiment will be described. In the following description, the differences from the first embodiment and the second embodiment will be mainly described, and the points overlapping with the first embodiment and the second embodiment will be omitted.

FIG. 19 shows a differential output circuit as a differential circuit included in the analog IP10 in the third embodiment. The MOS unit group 1QA and the MOS unit group 2QA constitute part of the differential circuit as pair elements.

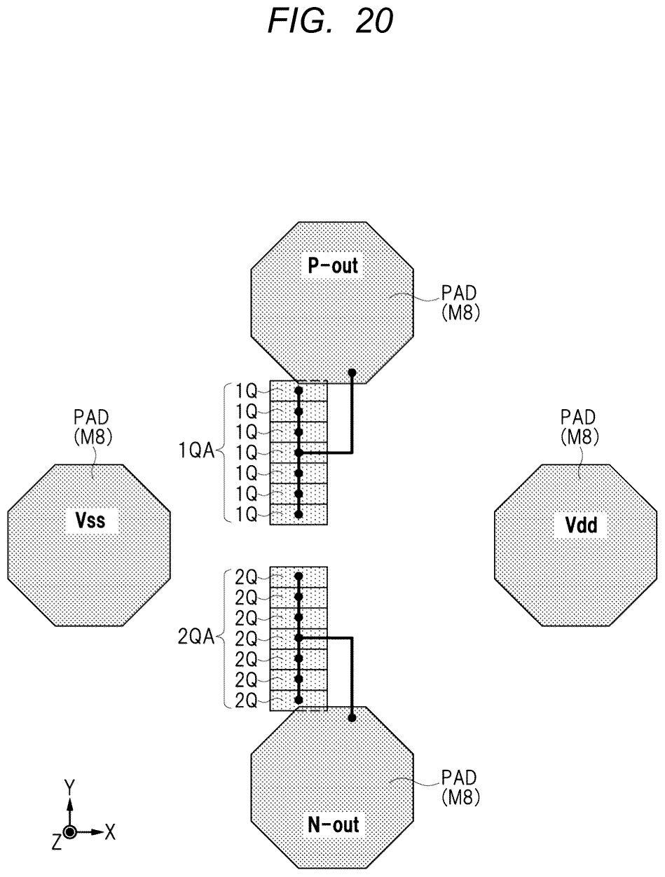

As shown in FIG. 20, the MOS unit group 1QA consists of a plurality of the MOS units 10, and the MOS unit group 2QA consists of a plurality of the MOS units 20. The number of the plurality of the MOS units 10 is equal to the number of the plurality of the MOS units 20.

In the equivalent circuit diagram of FIG. 19, the MOS unit group 1QA shows a state where the plurality of the MOS units 10 are connected in parallel, and the MOS unit group 2QA shows a state where the plurality of the MOS units 20 are connected in parallel.

In the case of a differential output circuit like FIG. 19, since the size of each of the MOS unit group 1QA and the MOS unit group 2QA is relatively large, each part of the MOS unit group 1QA and the MOS unit group 2QA is easily covered by the pad electrode PAD. The coverage rate of the MOS unit group 1QA and the coverage rate of the MOS unit group 2QA are made the same to prevent characteristic variations of the pair elements.

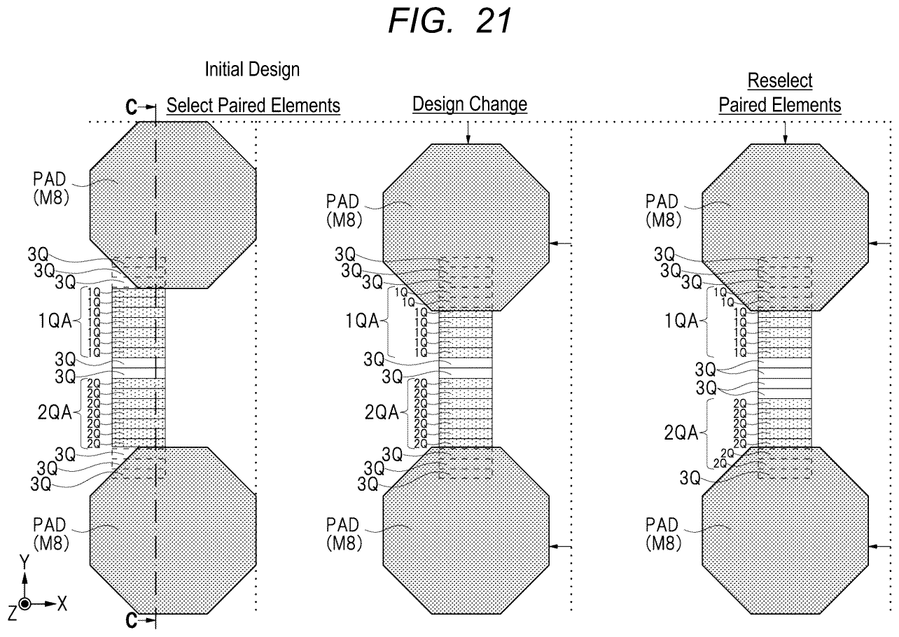

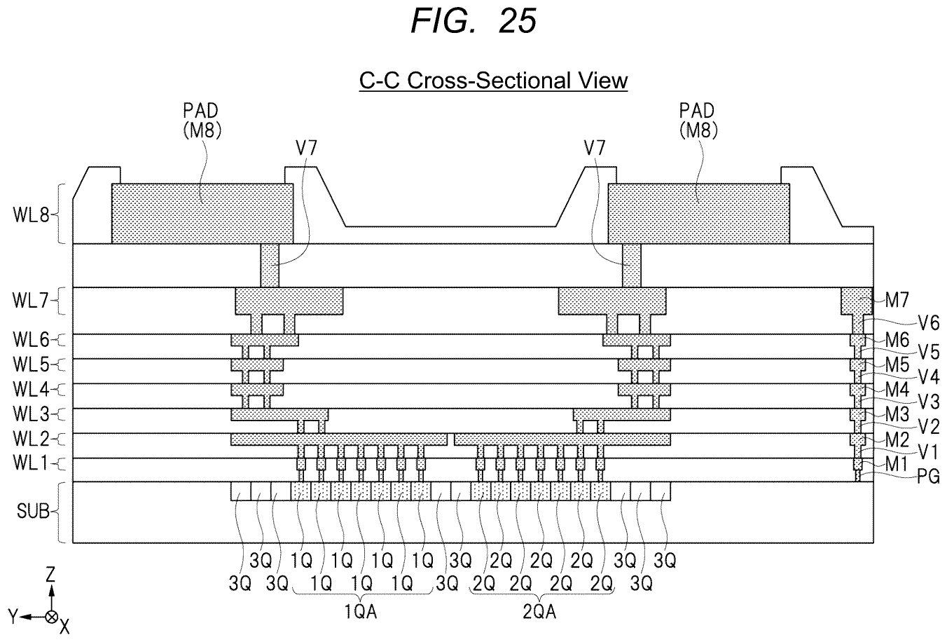

Below, using FIGS. 21 to 25, the design method of the semiconductor device 100 in the third embodiment will be described. FIG. 25 is a cross-sectional view along line C-C shown in FIG. 21. In the third embodiment, as in the first embodiment, steps S1 to S5 shown in FIG. 6 are performed.

First, in step S1, as shown in “Initial Design” of FIG. 21, a plurality of the MOS units 30, which are arranged adjacent to each other on the main surface of the semiconductor substrate in a plan view, are prepared.

Next, in step S2, among the multilayer wiring layers formed above the plurality of the MOS units 30, a plurality of wirings M8 formed in the uppermost wiring layer (wiring layer WL8) are prepared. Then, the pitch between each wiring M8 is designed, and the layout of the plurality of wirings M8 is performed.

Next, in step S3, as shown in FIG. 25, a plurality of the MOS units 10 and a plurality of the MOS units 20, which constitute part of the differential circuit as pair elements, are selected from the plurality of the MOS units 30. Here, the coverage rate of the MOS unit group 10A covered by the wiring M8 in a plan view is the same as the coverage rate of the MOS unit group 2QA covered by the wiring M8 in a plan view. Therefore, in the third embodiment, as in the first embodiment, characteristic variations of the pair elements do not occur.

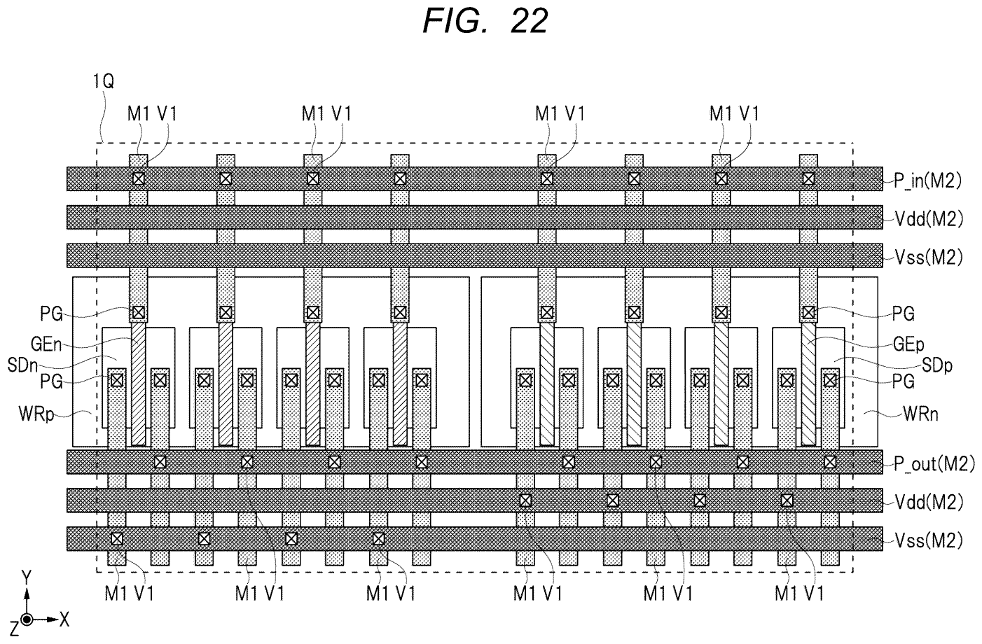

As shown in FIGS. 22, 23, and 24, the plurality of the MOS units 10, 20, and 30 in the third embodiment are each composed of one or more n-type MOSFETs and one or more p-type MOSFETs. The number of one or more n-type MOSFETs is equal to the number of one or more p-type MOSFETs.

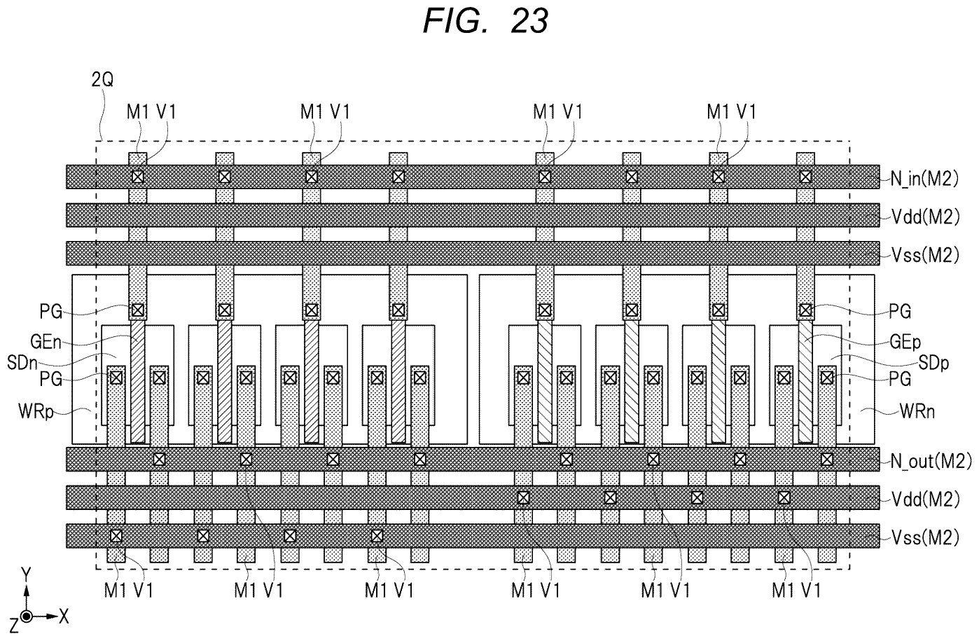

The n-type MOSFET has a p-type well region WRp, an n-type gate electrode GEn, and two impurity regions SDn that become the source region or the drain region. The p-type MOSFET has an n-type well region WRn, a p-type gate electrode GEp, and two impurity regions SDp that become the source region or the drain region. As shown in FIGS. 22 and 23, in the MOS unit 10 and the MOS unit 20, one or more n-type MOSFETs and one or more p-type MOSFETs are connected in an inverter configuration, respectively.

Note that among the plurality of the MOS units 30, other MOS units 30 excluding the MOS unit group 10A and the MOS unit group 2QA are not used in the differential circuit and other circuits. In the third embodiment, as in the second embodiment, a plurality of wirings formed in a wiring layer lower than the wiring layer WL8 and used for the connection of the differential circuit are used to select the plurality of the MOS units 10 and the plurality of the MOS units 20.

For example, as shown in FIGS. 22, 23, and 24, the gate electrode GEn and the impurity region SDn of the n-type MOSFET, and the gate electrodes GEp and the impurity region SDp of the p-type MOSFET are electrically connected to a plurality of wiring M1 by plugs PG, respectively. The plurality of wiring M1 is electrically connected to a plurality of wiring M2 by vias V1, respectively.

By changing the arrangement of the vias V1 connecting the wiring M1 and the wiring M2, the plurality of the MOS units 10 and the plurality of the MOS units 20 can be electrically connected to the wiring corresponding to the equivalent circuit of FIG. 19, and the plurality of the MOS units 30 that were not selected can be rendered unusable. For example, the gate electrode GEn and the impurity region SDn of the n-type MOSFET of the unselected the MOS unit 30 are connected to the ground potential Vss, respectively, and the gate electrode GEp and the impurity region SDp of the p-type MOSFET of the unselected the MOS unit 30 are connected to the power supply potential Vdd, respectively.

The differential output circuit of the third embodiment also carries a large current, similar to the differential input circuit of the second embodiment. Therefore, by switching the wiring through the change in the arrangement of the vias V1, the influence of the resistance component on the current path of the differential output circuit can be avoided. Moreover, such a configuration can minimize the wiring load connected to the pair elements.

Subsequently, as shown in “Design Change” of FIG. 21, the pitch between each wiring M8 may be changed. In step S4, if the pitch between each wiring M8 is changed (YES), the reselection of a plurality of the MOS units 10 and a plurality of the MOS units 20 is performed in step S5.

In step S5, as shown in “Reselection of Pair Elements” in FIG. 21, the plurality of the MOS units 10 and the plurality of the MOS units 20 are reselected from a plurality of the MOS units 3Q so that the coverage rate of the MOS unit group 1QA and the coverage rate of the MOS unit group 2QA are the same.

In this way, even in the third embodiment, as in the first embodiment and the second embodiment, the plurality of the MOS units 10 and the plurality of the MOS units 20 can be reselected even if the pitch between each wiring M8 is changed, so that characteristic variations of the pair elements do not occur.

### Fourth Embodiment

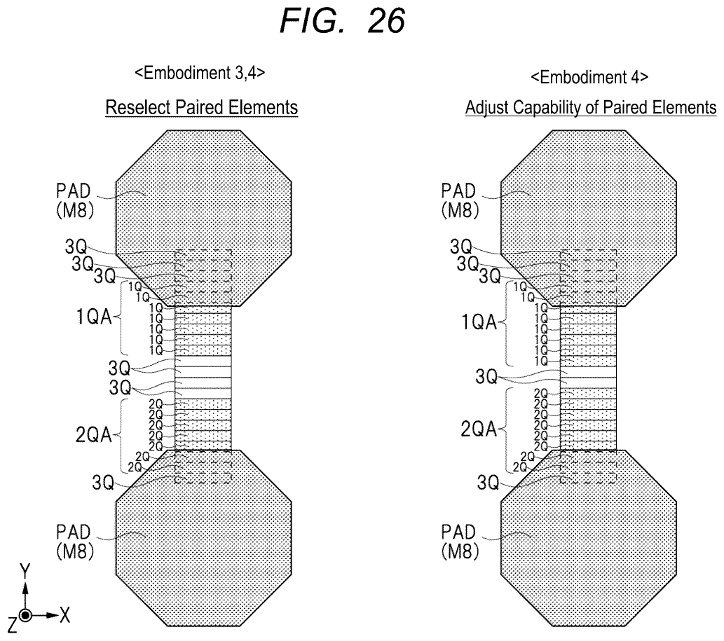

The design method of the semiconductor device 100 in the fourth embodiment will be described below with reference to FIG. 26. In the following description, the differences from the first embodiment to the third embodiment will be mainly explained, and the points overlapping with the first embodiment to the third embodiment will be omitted.

In the fourth embodiment, the unused MOS units 30 are used as elements for adjusting the capability of the differential circuit. For example, even with the same analog IP10, there may be cases where fine adjustments of the differential circuit's capability are required due to individual customer demands. In such cases, technology that can respond flexibly and promptly is provided.

That is, as illustrated in the third embodiment, as shown in FIG. 26, after step S5 in FIG. 6, at least one or more the MOS units 10 are added from the plurality of the MOS units 30 to the MOS unit group 1QA, and the same number of added the MOS units 10 are added from the plurality of the MOS units 30 to the MOS unit group 20A. In this way, by adding the unused MOS units 30 as the MOS units 10 and the MOS units 20 to the differential circuit, fine adjustments of the differential circuit's capability can be made.

Although the present invention has been specifically described based on the above embodiments, the present invention is not limited to the above embodiments, and various modifications can be made without departing from the gist thereof.

What is claimed is:

1. A semiconductor device comprising:
a semiconductor substrate having a first surface;
a plurality of MOS units arranged adjacent to each other on the first surface of the semiconductor substrate;
wherein each of the plurality of MOS units is comprised of at least one MOSFET and has same structure,
a multilayer wiring layer formed above the plurality of the MOS units; and
a first wiring formed on the topmost wiring layer of the multilayer wiring layer,
wherein each of the plurality of the MOS units includes a first MOS unit and a second the MOS unit constituting part of a differential circuit as pair elements, and
wherein, in the plan view, a coverage rate of the first MOS unit covered by the first wiring is the same as a coverage rate of the second MOS unit covered by the first wiring.

2. The semiconductor device according to claim 1,
wherein the other the MOS units excluding the first MOS unit and the second MOS unit among the plurality of the MOS units are not used in the differential circuit and other circuits.

3. The semiconductor device according to claim 1,
wherein the wiring thickness of the first wiring is thicker than the wiring thickness of other wirings formed in the multilayer wiring layer.

4. The semiconductor device according to claim 3,
wherein the first wiring includes a pad electrode for connecting an external connection member.

5. The semiconductor device according to claim 1,
wherein each of the plurality of the MOS units is composed of one n-type MOSFET or one p-type MOSFET.

6. The semiconductor device according to claim 1,
wherein each of the plurality of the MOS units is composed of one or more n-type MOSFETs and one or more p-type MOSFETs, the number of the one or more n-type MOSFETs is the same as the number of the one or more p-type MOSFETs, and in the first MOS unit and the second MOS unit, the one or more n-type MOSFETs and the one or more p-type MOSFETs are inverter-connected.

7. The semiconductor device according to claim 1,
wherein the first MOS unit and the second MOS unit included in the plurality of the MOS units are each multiple,
wherein the number of the plurality of first MOS units is equal to the number of the plurality of second MOS units, and
wherein, when the plurality of first MOS units are set as the first MOS unit group and the plurality of second MOS units are set as the second MOS unit group, a coverage rate of the first MOS unit group covered by the first wiring in the plan view is the same as a coverage rate of the second MOS unit group covered by the first wiring in the plan view.

8. A method for designing a semiconductor device comprising:
(a) preparing a plurality of MOS units arranged adjacent to each other on a first surface of the semiconductor substrate;
wherein each of the plurality of MOS units is comprised of at least one MOSFET and has same structure,
(b) preparing a first wiring formed on the topmost wiring layer of the multilayer wiring layer formed above the plurality of MOS units; and
(c) selecting a first MOS unit and a second MOS unit constituting part of a differential circuit as pair elements from the plurality of MOS units so that the coverage rate of the first MOS unit covered by the first wiring in the plan view is the same as the coverage rate of the second MOS unit covered by the first wiring in the plan view.

9. The method for designing a semiconductor device according to claim 8,
wherein the wiring thickness of the first wiring is thicker than the wiring thickness of other wirings formed in the multilayer wiring layer.

10. The method for designing a semiconductor device according to claim 9,
wherein the first wiring is used as a pad electrode for connecting an external connection member.

11. The method for designing a semiconductor device according to claim 8,
wherein each of the plurality of MOS units is composed of one n-type MOSFET or one p-type MOSFET.

12. The method for designing a semiconductor device according to claim 8,
wherein each of the plurality of MOS units is composed of one or more n-type MOSFETs and one or more p-type MOSFETs, the number of the one or more n-type MOSFETs is the same as the number of the one or more p-type MOSFETs, and in the first MOS unit and the second MOS unit, the one or more n-type MOSFETs and the one or more p-type MOSFETs are inverter-connected.

13. The method for designing a semiconductor device according to claim 8,
wherein in the step (c), the plurality of first MOS units and the plurality of second MOS units constituting part of the differential circuit are selected from the plurality of MOS units,
wherein the number of the plurality of first MOS units is equal to the number of the plurality of second MOS units, and
wherein in the step (c), when the plurality of first MOS units are set as the first MOS unit group and the plurality of second MOS units are set as the second MOS unit group, the coverage rate of the first MOS unit group covered by the first wiring in the plan view is the same as the coverage rate of the second MOS unit group covered by the first wiring in the plan view.

14. The method for designing a semiconductor device according to claim 8, further comprising:
(d) if the pitch between each wiring formed on the topmost wiring layer is changed after the step (c), reselecting the first MOS unit and the second MOS unit from the plurality of MOS units so that the coverage rate of the first MOS unit and the coverage rate of the second MOS unit are the same.

15. The method for designing a semiconductor device according to claim 14, further comprising:
(e) preparing a control circuit and a register electrically connected to the plurality of MOS units,
wherein the register stores information regarding the coverage rate covered by the first wiring for each of the plurality of MOS units in the plan view, and
wherein in the step (c) and the step (d), the control circuit automatically selects the first MOS unit and the second MOS unit from the plurality of MOS units based on the information of the register so that the coverage rate covered by the first wiring in the plan view is the same.

16. The method for designing a semiconductor device according to claim 14, further comprising:
(f) preparing a plurality of second wirings formed in the wiring layer below the topmost wiring layer of the multilayer wiring layer and used for the connection of the differential circuit, and
wherein in the step (c) and the step (d), electrically connecting the selected first MOS unit and the second MOS unit from the plurality of MOS units to the multiple second wirings and disabling the other unselected MOS units.

17. The method for designing a semiconductor device according to claim 14,
wherein in step (c), selecting a plurality of the first MOS units and a plurality of the second MOS units, which form a part of the differential circuit, from the plurality of MOS units,
wherein the number of the plurality of the first MOS units is the same as the number of the plurality of the second MOS units,
wherein in step (c), when the plurality of the first MOS units are grouped as the first MOS unit group and the plurality of the second MOS units are grouped as the second MOS unit group, the coverage rate of the first MOS unit group covered by the first wiring in a plan view is the same as the coverage rate of the second MOS unit group covered by the first wiring in a plan view, and
wherein in step (d), the first MOS units and the second MOS units are reselected from the plurality of MOS units so that the coverage rate of the first MOS unit group and the coverage rate of the second MOS unit group are the same.

18. The method for designing a semiconductor device according to claim 17, further comprising:
(g) after step (d), adding at least one or more of the first MOS units from the plurality of MOS units to the first MOS unit group, and adding the same number of the second MOS units as the added first MOS units from the plurality of MOS units to the second MOS unit group.
